(19) United States
(12) Patent Application Publication
(10) Pub. No.: US 2020/0265364 A1
(43) Pub. Date: Aug. 20, 2020

(54) SYSTEMS, METHODS AND COMPUTER PROGRAM PRODUCT FOR SUPERVISION & IMPROVEMENT OF OFFICER PERFORMANCE

(71) Applicant: JONATHAN PARHAM, RAHWAY, NJ (US)

(72) Inventor: JONATHAN PARHAM, RAHWAY, NJ (US)

(21) Appl. No.: 16/794,072

(22) Filed: Feb. 18, 2020

Related U.S. Application Data
(60) Provisional application No. 62/806,433, filed on Feb. 15, 2019.

(51) Int. Cl. G06Q 10/06; G06Q 50/26

(52) U.S. Cl. CPC G06Q 10/06398; G06Q 50/265

(57) ABSTRACT

A system, methods and computer program product for law enforcement performance management is disclosed. The contemplated invention makes use of processors and modules for the collection, analysis and operation of system components regarding a law enforcement official's conduct, analysis and review before, during and after an incident. Additional aspects of the contemplated invention contemplate use of modules and sub-modules for incident data collection, post-incident training, analysis and review.

### CROSS-REFERENCE TO RELATED APPLICATIONS AND PRIORITY CLAIMS

This patent application is a Non-Provisional Patent Application which claims priority to, from, U.S. Provisional Patent Application Ser. No. 62/806,433, titled “Systems, Methods and Computer Program Product for Supervision & Improvement of Officer Performance” filed Feb. 15, 2019. The entire disclosure of the aforementioned provisional patent application is incorporated by reference as if fully stated herein.

### FIELD OF THE INVENTION

The present invention is generally related to computer implemented methods, systems and computer program product directed to the supervision, and improvement of officer performance. Specifically, the use of computer implemented methods, systems and computer program product directed towards, inter alia, the provision of direction, analysis and review of officer conduct.

### BACKGROUND OF THE INVENTION

Police officer error resulting from lack of proper training, inexperience, and poorly supervised police officers cause significant financial loss to municipalities in the form of multi-million-dollar civil suits. In addition, the municipalities suffer negative public perception due to poor delivery of law enforcement services and the negative media attention that follows. Further still, police error results in declining conviction rates due to improper police processes during arrest procedures, while also causing increase in lost time, and officer injuries. With the ever-increasing calls for service, manpower restrictions and minimal training time, the job of policing has become mentally, physically and emotionally challenging. As stress increases, memory decreases and mistakes become inevitable. As such, there exists a need for a system and/or mobile application that helps guide, train and direct police officers in the execution of their duties. There is also a need for a data gathering system that enables the collection of police conduct in real-time thereby enabling supervisory correction of police errors sooner rather than later. There is also a need for a system that provides incident-specific instructions at the push of a button, reminding officers of critical information when they need it the most.

### SUMMARY OF THE INVENTION

Aspects of embodiments of the present invention contemplate systems, methods, computer program product and/or devices which are directed to the implementation and operational functionality of, inter alia, mobile application systems, systems, computer program product, methods for the provision of guidance to police officers in the execution of their duties.

Aspects of embodiments of the present invention help improve police officer performance by providing instant access to incident specific tasks. In one aspect, this may be in the form of checklists which help reduce officer error, while providing the officer and his/her supervisor with a knowledge management resource that is accessible at a moment's notice.

Aspects of embodiments of the present invention provides a holistic performance management, risk management, and knowledge management tool wrapped in one mobile platform/system.

Aspects of embodiments of the present invention contemplate generation and provision of audible checklists which may be spoken or downloaded to officers to improve performance and enhance memory retention.

Aspects of embodiments of the present invention contemplate generation and provision of building/structure floor plans of critical infrastructure, which may be provided on a moment's notice.

Aspects of embodiments of the present invention contemplate generation and provision of incident command tasks which may be presented to supervisors during high stress incidents when memory often fails most officers.

Aspects of embodiments of the present invention contemplate generation and provision of training resources as well as agency policy to officers and agencies.

Aspects of embodiments of the present invention also act as a task reminder, and performance review tool while also providing the trainer or supervisor a resource for collecting performance related data to ensure the tasks are completed in the acceptable manner.

Aspects of embodiments of the present invention bridge the training and supervisory gap left when police agencies either fail to, or are unable to adequately train their officers, or provide adequate supervisory oversight.

Aspects of embodiments of the present invention provide a mechanism for performance improvement by acting as an early warning system for improper police behavior. Supervisors are able to fill in drop down menus relative to an officer's performance and send that data to the database. The information is then collected and utilized to determine performance related issues and anomalies that require training, counseling, or discipline.

Aspects of embodiments of the present invention also operate as a risk management tool which helps to mitigate the financial and reputational loss that is associated with law enforcement error, such as high-priced civil lawsuits, and high medical costs associated with injuries resulting from an officer's error or misconduct.

Aspects of embodiments of the present invention systems, methods, computer program product and/or devices which are directed to operation, implementation, display and/or enablement of the following components, including:

Incident specific “verbal” instructions Using an interlinking module, incident-specific verbal instructions are provided to police officers en route to critical incidents—this up to date information allows the officer to focus on arriving to the scene safely, while reinforcing the agency approved response. The audible recording serves to remind the officer of incident specific tasks, while serving as a learning tool after multiple uses.

Access to & Provision of Floor plans: Access to critical infrastructure is provided by a module that links with infrastructure databases. Critical infrastructure captured or downloaded onto a mobile device can be shared with mutual aid resources, and used to identify anomalies such as bombs, or injured persons. Floor plans are also used to aid in task delegation where large areas are being covered by first responders

Access to & Provision of local, state, and federal laws and statutes, as well as agency specific standard operating procedures can be accessed on the go without the officer “calling” headquarters, access to these guidelines ensures the officer has the information needed to make the best decision for the incident they are responding to.

Performance Management Supervisory Resources Facilities/Modules
a. Incident Command Module: This facility or module provides a checklist of critical tasks for incident commanders during high risk incidents and enables supervisors to ensure that all necessary tasks are completed during the most critical stage of a high-risk incident. In an aspect of an embodiment of the present invention, the checklist may be audially provided to the Officer either live or as a recording.
b. After Action Review: With this facility or module, critical incidents and lessons learned may be captured instantaneously, and later utilized to improve future police performance.
c. Daily Observation Reports (DOR): With this facility or module, performance of newly hired trainees may be captured on the spot, without coming off the road. The “DOW” is used as a performance monitoring tool that measures day to day progress
d. Performance Review: This facility or module enables performance reviews and actual performance of officers to be automatically collated into an annual performance evaluation report. A supervisor will no longer need to try and remember the actions taken by the police officer during the rating period. As information is added to the database it is saved to be used later for the annual performance evaluation.
e. Chat: With this facility or module, officers are able to share pictures and text instantly to other officers without being forced to return to their in-vehicle computer, or returning to headquarters for additional information.
f. Address Book: Every agency resource is identified and contact information stored within this function. This allows officers to contact any agency resource via email or otherwise.
g. Body-worn camera Review: this icon provides access to a form that captures data or enables a Supervisor's assessment of an officer's performance captured on the officer's body worn camera. Random audits serve as training needs assessments, resource guides, and early warning systems for problematic officers, as well as identifying officers who deserve commendations.

Training Videos: Agency training is captured on video and made accessible under this icon. Items like administering Narcan, or establishing a perimeter are spelled out in short videos, allowing officers to train on the go.

The contemplated invention provides advantages to users as Officer performance is improved on the individual level by providing the officer with an audible checklist for each incident type they are responding to. This reminder serves to improve the likelihood the officer will perform all of the tasks require for successful task completion. Repeated use of the contemplated invention reinforces an Officer's proper and correct response in any situation. Further, because Officers using the contemplated invention would have incident-specific information at their fingertips, they worry less about what to do and focus on arriving at the scene safely. This would lead in the reduction of stress amongst Officers.

Officer performance is also improved on the agency level because the supervisors have access to performance monitoring tools that capture data while it is fresh in the supervisor's mind, reducing the likelihood of the supervisor becoming too busy or just forgetting the information. Supervisors are also able to conduct on-the-spot performance reviews while the incident is still fresh in their memory.

The agency benefits because the monitoring tools serve as an early warning system to detect officer behavior that is inconsistent with agency standards.

The contemplated invention addresses the unfortunate result of what occurs when humans are placed in high stress situations with poor training and minimal supervision—error.

It also helps to eliminate the effects of stress on the officer's memory. The consistent use of this tool not only reinforces the desired performance response, it also ensures consistency and predictability in agency knowledge. Officers no longer forget what to do because of the excitement of the moment because they repeatedly are reminded with the critical task list instructions.

The instructions provided by the contemplated invention also address the steps that mitigate the most commonly occurring errors that law enforcement officers commit; for example, running red lights causing accidents as a result of auditory exclusion resulting from stress.

Consistent use of aspects of embodiments of the present invention:
a. improves officer performance, reduces financial loss, increases public trust, and helps identify problem officers
b. enables the capture of performance data on forms, which then could be reviewed to determine training needs, high risk officers, agency policy gaps, and officer behavior inconsistent with agency standards.
c. enables development of plans to mitigate previously observed effects (counseling, training, discipline)
d. enables the monitoring of changes in critical areas previously identified

The contemplated invention may be used by any organization where
An existing standard of conduct has been established
An existing set of key performance indicators has been established
Task specific risks have been identified
Industry-wide body of knowledge exists
Poor performance creates risk for financial loss
Poor performance creates risk for reputational loss
Poor performance increases opportunity for injury

The agency benefits because the monitoring tools serve as an early warning system to detect officer behavior that is inconsistent with agency standards.

Contemplated Systems, Methods, Computer Program Product

Aspects of embodiments of the present invention contemplate the use of modules in implementation of the process(es) outlined herein and operation of components of the system also disclosed herein. In an aspect of an embodiment of the present invention, the term “module” may represent self-contained computer hardware. In another aspect of an embodiment of the present invention, the term “module” may represent computer hardware on a designated computer chip or separate computer chips. In yet another aspect of an embodiment of the present invention, the processor may be configured to perform tasks not undertaken by the module(s) disclosed herein. In a further aspect of an embodiment of the present invention, the modules may be hardware resident on one chip, component, separate components, a remote server, database, some or each of which (or all of which, in one aspect of an embodiment of the present invention) may be separate and distinct from the device, or any combination thereof. In one aspect of an embodiment of the present invention, the processor may be configured to coordinate, implement and/or assign tasks to, from and/or among the module(s). In a further aspect of an embodiment of the present invention, “module” may represent operational cooperation between system components. For instance, the officer module may comprise of the one or more processors, memory, computer executable instructions (code) executable by the processor(s) and resident within memory location(s) etc. with each component being in communication with one or more other components in the module and each component working with the other component(s) to conduct the desired operation for which the module is configured to do e.g. comparison or scoring of data structure values(s). In a further aspect of an embodiment of the present invention, module components may also, in an operational context, be components of other modules. These modules may be components of server(s)/processor(s) which are configured to perform a predefined set of basic operations in response to receiving a corresponding basic instruction selected from a predefined native instruction set of computer executable codes. The modules then may include a set of machine codes selected from the native instructions set of the server(s)/processor(s) to perform specific functions and/or operations. The native instructions set is a discrete code recognized by the hardware processor(s) and may be built into the hardware processor(s) and presents the way the system communicates with the hardware processor(s). In an aspect of an embodiment of the present invention, the native instructions set specify certain registers for arithmetic, addressing and/or control functions. In addition, the native instructions set can specify addressing modes which are utilized to interpret operands. Combination and/or permutations of the different native instructions may be done for more complex computer operations or functionality.

In an aspect of an embodiment of the present invention, each module may include sub-modules, which in turn may include any one or more memory structures such as register(s), sub-register(s), data structure(s), pointer(s) etc. where each memory structure may be used to store information for the module. In an aspect of an embodiment of the present invention, the processor(s) may determine, based on the module and/or application, which memory structure(s) to use for the execution of certain tasks. In one aspect of an embodiment of the present invention, this may be a combination of different memory structures for efficient provision of information or the execution of a task, in which case, in an aspect of an embodiment of the present invention, the processor(s) may determine the memory structures and/or combination of memory structures to use for computing and operational efficiency. In an aspect of an embodiment of the present invention, this may be based on the incident type. For example, where the incident type is much more of an emergency, then the processor(s) may determine the best memory structures to use for the fast retrieval of the information in the memory structure. The terms “register”, “data structure”, “sub-register”, “pointer” etc. are terms as known, defined, used in the art. In an aspect of an embodiment of the present invention, each memory structure may be used to store data or information relevant to the sub-module

It should be noted that the numbers of sub-register, data structures, registers etc. as disclosed herein are for illustrative purposes only as additional or fewer sub-register, data structures, incident registers etc. are also contemplated as needed according to aspects of embodiments of the present invention.

A further aspect of an embodiment of the present invention contemplates use of computer program product which may include a computer usable medium having control logic stored on it for causing one or more processors and, in other aspects, sub-processors to perform all operations contemplated herein.

Further aspects of embodiments of the present invention contemplate the use of computer-implemented methods for the implementation and execution of the operations contemplated and disclosed herein.

Further aspects of embodiments of the present invention contemplate the use of computer-implemented methods which perform a predefined set of basic operations in response to receiving a corresponding basic instruction selected from a predefined native instruction set of codes in the implementation and execution of the operations contemplated and disclosed herein.

Aspect(s) of embodiment(s) of the present invention make use of hardware processor(s) configured to perform a predefined set of basic operations in response to receiving a corresponding basic instruction selected from a predefined native instruction set of codes.

Aspect(s) of embodiment(s) of the present invention make use of database system(s) which include data structure(s), register(s), sub-registers and pointer(s).

Aspects of embodiments of the present invention contemplate the use of modules, processor(s), sub-processor(s), and memory structure(s) which may include any one or more, or a combination of: data structure(s), register(s), sub-register(s) and pointer(s) in the display, implementation, operation and/or use of the following system components of the invention:

System Login
a. Email Address
b. Password
c. Login button
d. Forgot password link
e. Create new account link

Home Page: Main Menu
a. Incident Response—category list for call response type
   i. Assault
   ii. Bomb Threat
   iii. Burglary
   iv. Crash Report
   v. Domestic Violence
   vi. First Aid
   vii. Haz-mat
   viii. Juvenile Complaint
   ix. Mental Health
   x. Missing Persons
   xi. Narcotics
   xii. Sick Call
   xiii. Suspicious Persons
   xiv. Vandalism
   xv. Weapons Offenses
   xvi. Weather event
b. Floor Plans—pdf plans for critical infrastructure
   i. Schools
   ii. Government Buildings
   iii. Sports Arenas
   iv. Airport
   v. Movie Theatre
c. Laws & Statutes—legal source codes for law enforcement¹ ¹ It should be noted that the statutes, regulations shown here are exemplary only and not limiting.
   i. Title 2c: NJ Criminal Justice Code
   ii. New Jersey Attorney General Guidelines
   iii. New Jersey Motor Vehicle Code: Title 39
   iv. Municipal Ordinances
   v. Agency Standard Operating Procedures
d. Supervisor Resources: performance management tools for supervisors
   i. Incident Command Checklist
   ii. After Action Review
   iii. Daily Observation Report
   iv. Performance Review
   v. Body Worn Camera Review
e. Chat—text and picture information sharing
f. Address Book—Agency resources contact information
g. Training Resources—Agency training videos by topic
   i. Training Calendar
   ii. Incident Command
   iii. Mass Casualty
   iv. Crime Scene
   v. Medical
   vi. Patrol Tactics

Side Menu
a. User Profile
b. Logout
c. App Settings
d. App Content
e. Home
f. Contact Us
g. Incident Response
h. Maps
i. Laws & Statutes
j. Supervisor Resources
k. Chat
l. Training Videos

An aspect of an embodiment of the present invention contemplates a system for performance management, which may include: one or more processors, where the one or more processors may perform a predefined set of basic operations in response to receiving a corresponding basic instruction selected from a predefined native instruction set of codes, memory in communication with the one or more processors, one or more operational modules, where the one or more operational modules may include any one or more of: an incident response module, a supervisor resources module, a training resources module, a floor plan module, a chat module, a laws, statutes and regulations module, a reminder module, where the one or more operational modules is in communication with the one or more processors, where the one or more operational modules may include one or more sub-modules, a display module in communication with the one or more processors, and a transceiver module for receipt and transmission of data to and from one or more electronic devices in communication with the system, where each of the operational modules(s) is represented as an icon on a display, where each icon may include embedded code, execution of which activates operation of the operational module(s), leading to display of one or more sub-module icons representing one or more sub-modules, where the one or more sub-module icons may include embedded code, execution of which activates the one or more sub-modules.

In one aspect of an embodiment of the present invention, any one of the sub-modules may include any of: one or more memory structures, a pointer to memory structure(s), where activation of the sub-module(s), by selection of the representative icons of the one or more sub-modules, produces, provides and/or displays agency approved information for specific operational module(s). In an aspect of an embodiment of the present invention, the agency approved information could be any one or more of: audio recording(s), checklist(s), response instruction(s), display(s) of an applicable law, a statute or a regulation, fillable form(s), floor plan(s), audiovisual recording(s).

In one aspect of an embodiment of the present invention, the agency approved information may be resident on the one or more memory structures.

In one aspect of an embodiment of the present invention, execution of the embedded code may be done by any one or more of: physical contact, pressure, temperature contact of the icon(s) on the display.

Another aspect of an embodiment of the present invention contemplates a computer implemented method of performance management, which may include, executing on at least one processors, which perform a predefined set of basic operations in response to receiving a corresponding basic instruction selected from a predefined native instruction set of codes, execution of which enable operational steps of any one or more of: an incident response module, a supervisor resources module, and a training resources module.

In another aspect of an embodiment of the present invention the computer-implemented operational steps of the incident response module may include: activating the incident response module by selecting an incident response module icon representative of the incident response module on an electronic device where selection of the incident response module icon executes code embedded within the incident response module icon, display of one or more incident response sub-module icons, selection of the one or more incident response sub-module icons, where the selection executes code embedded within the one or more incident response sub-module icons thereby activating one or more incident response sub-modules, production, provision, and/or display of agency approved information for the operational module(s), where the agency approved information may be any one or more of: at least one audio recording, at least one checklist, at least one response instruction, at least one display of an applicable law, a statute or a regulation, at least one fillable form, at least one floor plan, at least one audiovisual recording, and operation of a reminder module, where the reminder module may be activated by any of: user activation of a reminder icon on the electronic device where selection of the icon executes code embedded within the icon, automatic activation following production of agency approved information, where activation of the reminder module may include provision of any one or more of: at least one reminder checklist, audio play of at least one reminder.

In another aspect of an embodiment of the present invention, the computer-implemented operational steps of the supervisor resources module may include: activating the supervisor resources module by selecting a supervisor resources module icon representative of the supervisor resources module on an electronic device where selection of the supervisor resources module icon executes code embedded within the supervisor resources module icon, display of at least one supervisor resources sub-module icon, selection of the at least one supervisor resources sub-module icon, where the selection executes code embedded within the supervisor resources sub-module icon(s) thereby activating at least one supervisor resources sub-module, display of any one or more of: at least one checklist, at least one questionnaire, at least one form on the electronic device, collection of input by a user in response to the any one or more of: at least one checklist, at least one questionnaire, at least one form on the electronic device, submission of the collected input to at least one database, and recordation of the collected input on the at least one database.

In another aspect of an embodiment of the present invention, the contemplated computer-implemented operational steps may include use of the collected input for any one or more of: agency training needs assessment, risk management, early warning system resource deployment planning.

In another aspect of an embodiment of the present invention, the contemplated computer-implemented operational steps of the training resources module may include: activating the training resources module by selecting a training resources module icon representative of the training resources module on an electronic device where selection of the training resources module icon executes code embedded within the training resources module icon, display of at least one training resources sub-module icon, and selection of the at least one training resources sub-module icon, where the selection executes code embedded within the at least one training resources sub-module icon thereby activating at least one training resources sub-module.

In another aspect of an embodiment of the present invention, activation of the training resources sub-module(s) may include: display of at least one training calendar, where the training calendar(s) may include at agency and/or individualized training event(s) posted on the training calendar(s), enabling selection of the agency and/or individualized training event(s) posted on the training calendar(s), where the selection may be done by any one of: date selection, event selection, and recordation of the selection.

In another aspect of an embodiment of the present invention, activation of the training resources sub-module(s) may include: display of at least one training resource on the electronic device, enabling selection of the training resource(s) as displayed on the electronic device, and enabling operation on the selected training resource(s), where the operation may be any one or more of: download of the at least one training resource onto the electronic device, play of the at least one training resource on the electronic device.

A further aspect of an embodiment of the present invention contemplates a computer program product which may include a non-transitory computer-readable storage medium having computer-readable code embodied in the medium which, when executed on at least one processors activate/initiate operation of any one or more of: an incident response module, a supervisor resources module, and a training resources module.

In a further aspect of an embodiment of the present invention, the computer program product for the operation of the incident response module may include computer-readable code for: activating the incident response module by selecting an incident response module icon representative of the incident response module on an electronic device where selection of the incident response module icon executes code embedded within the incident response module icon, display of at least one incident response sub-module icon, selection of the at least one incident response sub-module icon, where the selection executes code embedded within the at least one incident response sub-module icon thereby activating at least one incident response sub-module, production, provision, and/or display of agency approved information for the at least one operational modules, where the agency approved information may be any one or more of: at least one audio recording, at least one checklist, at least one response instruction, at least one display of an applicable law, a statute or a regulation, at least one fillable form, at least one floor plan, at least one audiovisual recording, and operation of a reminder module, where the reminder module may be activated by any of: user activation of a reminder icon on the electronic device where selection of the icon executes code embedded within the icon, automatic activation following production of agency approved information, where activation of the reminder module may include provision of any one or more of: at least one reminder checklist, audio play of at least one reminder.

In a further aspect of an embodiment of the present invention, the computer program product for the supervisor resources module may include computer-readable code for: activating the supervisor resources module by selecting a supervisor resources module icon representative of the supervisor resources module on an electronic device where selection of the supervisor resources module icon executes code embedded within the supervisor resources module icon, display of at least one supervisor resources sub-module icon, selection of the at least one supervisor resources sub-module icon, where the selection executes code embedded within the at least one supervisor resources sub-module icon thereby activating at least one supervisor resources sub-modules, display of any one or more of: at least one checklist, at least one questionnaire, at least one form on the electronic device, collection of input by a user in response to the any one or more of: at least one checklist, at least one questionnaire, at least one form on the electronic device, submission of the collected input to at least one database, and recordation of the collected input on the at least one database.

In a further aspect of an embodiment of the present invention, the computer program product for the supervisor resources module may include computer-readable code for use of the collected input for any one or more of: agency training needs assessment, risk management, early warning system resource deployment planning.

In a further aspect of an embodiment of the present invention, the computer program product for operation of the training resources module may include computer-readable code for: activating the training resources module by selecting a training resources module icon representative of the training resources module on an electronic device where selection of the training resources module icon executes code embedded within the training resources module icon, display of at least one training resources sub-module icon, and selection of the at least one training resources sub-module icon, where the selection executes code embedded within the at least one training resources sub-module icon thereby activating at least one training resources sub-modules.

In a further aspect of an embodiment of the present invention, the computer program product for operation of the training resources sub-modules may include computer-readable code for: display of at least one training calendar, where the at least one training calendar may include at least one agency and individualized training event posted on the at least one training calendar, enabling selection of the at least one agency and individualized training event posted on the at least one training calendar, where the selection is by any one of: date selection, event selection, and recordation of the selection.

In a further aspect of an embodiment of the present invention, the computer program product for operation of the training resources sub-modules may include computer-readable code for: display of at least one training resource on the electronic device, enabling selection of the at least one training resource as displayed on the electronic device, and enabling operation on the selected at least one training resource, where the operation is any one or more of: download of the at least one training resource onto the electronic device, play of the at least one training resource on the electronic device.

A yet further aspect of an embodiment of the present invention contemplates a method for displaying a performance management screen (which could be a screen or display for an electronic device), comprising, executing on at least one graphical interface processor, which performs a predefined set of basic operations in response to receiving a corresponding basic instruction selected from a predefined native instruction set of codes, execution of which enable any one or more of: dynamically displaying an icon representative of an incident response module, dynamically displaying an icon representative of a supervisor resources module, and dynamically displaying an icon representative of a training resources module, wherein each icon comprises of embedded code, execution of which activates a module of which the icon is respectively representative of.

In a yet further aspect of an embodiment of the present invention the method for displaying a performance management screen may include: dynamically displaying at least one incident response sub-module icon by selecting the incident response module icon representative of the incident response module on the screen wherein selection of the incident response module icon executes code embedded within the incident response module icon, activating at least one incident response sub-module, wherein activation is effected by selection of the at least one incident response sub-module icon, wherein the selection executes code embedded within the at least one incident response sub-module icon, displaying agency approved information for the at least one incident response sub-module, wherein the agency approved information is any one or more of: at least one audio recording, at least one checklist, at least one response instruction, at least one display of an applicable law, a statute or a regulation, at least one fillable form, at least one floor plan, at least one audiovisual recording, and display of a reminder module, wherein the reminder module is activated by any of: user activation of a reminder icon on the screen wherein selection of the icon executes code embedded within the icon, automatic activation following production of agency approved information, wherein activation of the reminder module comprises of display of any one or more of: at least one reminder checklist, audio play of at least one reminder.

In a yet further aspect of an embodiment of the present invention the method for displaying a performance management screen may include: dynamically displaying at least one supervisor resources sub-module icon by selecting the supervisor resources module icon representative of the supervisor resources module on the screen wherein selection of the supervisor resources module icon executes code embedded within the supervisor resources module icon, selection of the at least one supervisor resources sub-module icon, wherein the selection executes code embedded within the at least one supervisor resources sub-module icon thereby activating at least one supervisor resources sub-module, display of any one or more of: at least one checklist, at least one questionnaire, at least one form on the screen, display of user input on the screen in response to the any one or more of: at least one checklist, at least one questionnaire, at least one form on the electronic device, submission of the user input to at least one database, and recordation of the user input on the at least one database.

In a yet further aspect of an embodiment of the present invention the method for displaying a performance management screen may include: dynamically displaying at least one training resources sub-module icon by selecting the training resources module icon representative of the training resources module on the screen, wherein selection of the training resources module icon executes code embedded within the training resources module icon, and activating the at least one training resources sub-module by selection of the at least one training resources sub-module icon, wherein the selection executes code embedded within the at least one training resources sub-module icon.

In a yet further aspect of an embodiment of the present invention the method for displaying a performance management screen may include: dynamically displaying at least one training resources sub-module icon by selecting the training resources module icon representative of the training resources module on the screen, wherein selection of the training resources module icon executes code embedded within the training resources module icon, display of at least one training calendar, wherein the at least one training calendar comprises of at least one agency and individualized training event posted on the at least one training calendar, enabling selection of the at least one agency and individualized training event posted on the at least one training calendar, wherein the selection is by any one of: date selection, event selection, and recordation of the selection.

In a yet further aspect of an embodiment of the present invention the method for displaying a performance management screen may include: dynamically displaying at least one training resource on the screen by selecting the training resources module icon representative of the training resources module on the screen, wherein selection of the training resources module icon executes code embedded within the training resources module icon, and enabling operation on the selected at least one training resource, wherein the operation is any one or more of: download of the at least one training resource, play of the at least one training resource on the screen.

### BRIEF DESCRIPTION OF THE DRAWINGS

FIG. 1A. illustrates an exemplary operational system according to an aspect of an embodiment of the present invention.

FIG. 1B illustrates an Incident Response Module according to an aspect of an embodiment of the present invention.

FIG. 1C illustrates a Supervisor Resources Module according to an aspect of an embodiment of the present invention.

FIG. 1D illustrates a Training Resources Module according to an aspect of an embodiment of the present invention.

FIG. 2 illustrates an exemplary process flow for an incident response module according to an aspect of an embodiment of the present invention.

FIGS. 3A through 3D illustrate exemplary operational screen displays as displayed on an exemplary electronic device for an incident response module according to aspects of embodiments of the present invention.

FIG. 4 illustrates an exemplary process flow for supervisor resources module, a supervisor resources module according to an aspect of an embodiment of the present invention.

FIGS. 5A and 5B illustrate exemplary operational screen displays as displayed on an exemplary electronic device for a supervisor resources module according to aspects of embodiments of the present invention.

FIG. 6 illustrates an exemplary process flow for a training resources module according to an aspect of an embodiment of the present invention.

FIG. 7 illustrates an exemplary operational screen display as displayed on an exemplary electronic device for a training resources module according to an aspect of an embodiment of the present invention.

### DETAILED DESCRIPTION OF THE DRAWINGS

Operation of the Incident Response Module.

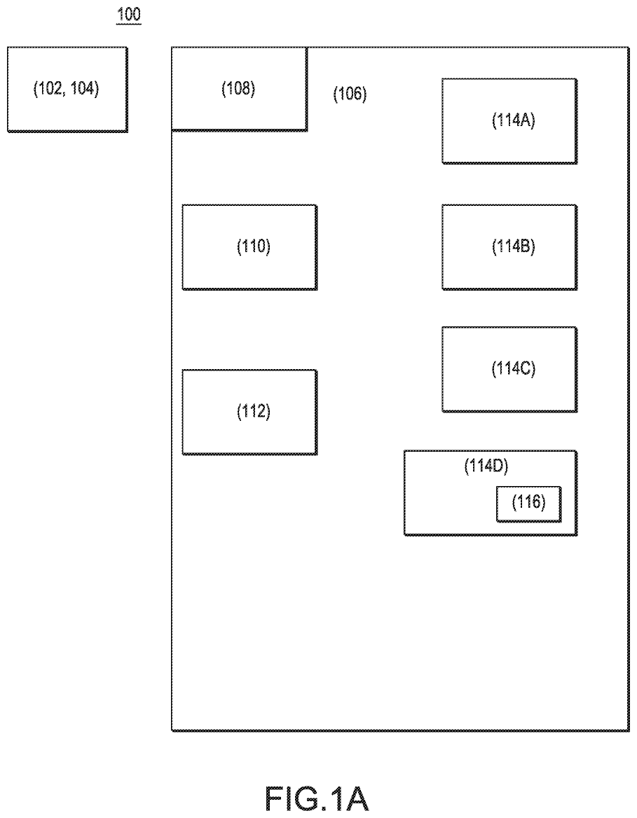

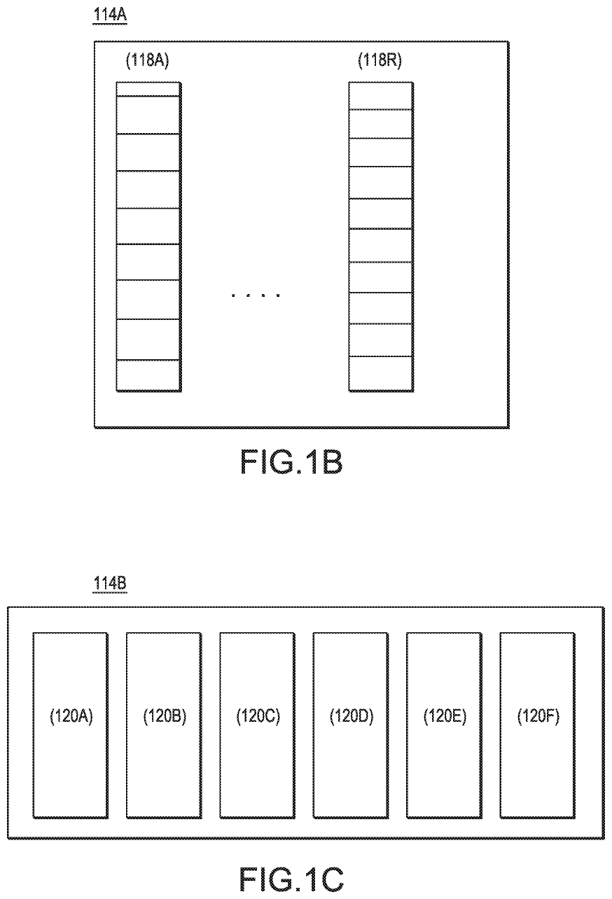

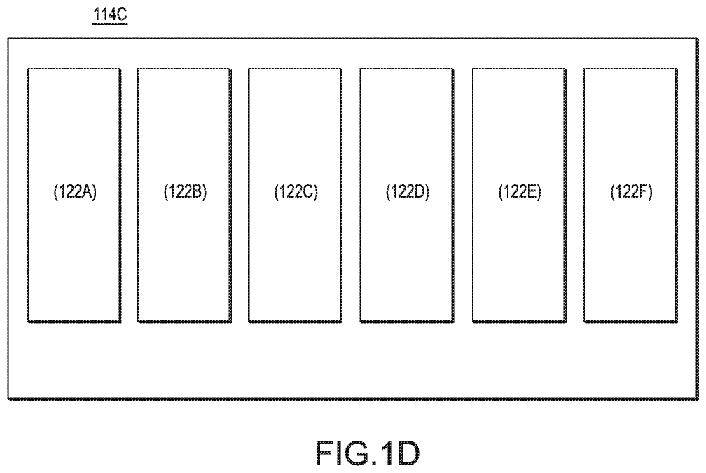

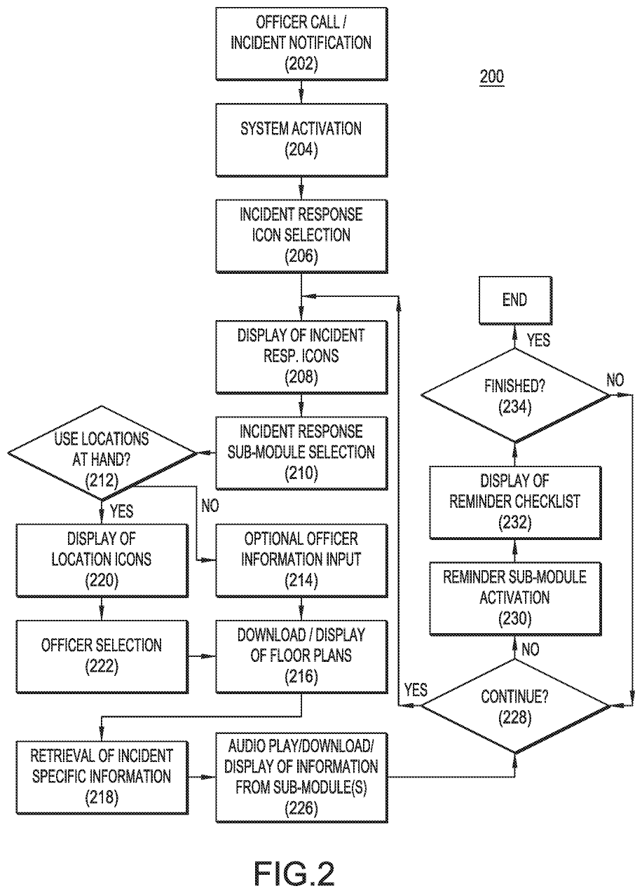

Referring now to FIGS. 1A-1B, 2 and 3A-3D, an exemplary system 100, incident response module 114A, an exemplary incident response module process flow 200, and exemplary operational screen displays 300 as displayed on exemplary electronic device(s) 102, 104 for an incident response module 114A are shown according to aspects of embodiments of the present invention.

FIGS. 1A through 1B illustrate overall exemplary system 100 and incident response module 114A where system 100 may include Officer electronic device(s) 102, 104 which may be in communication with main system component 106 which includes communication module 108 (such as, for an example, a transceiver device/component/sub-system) which communicates with electronic components 102, 104 to exchange data with electronic device(s) 102, 104. With this data transmission/communication, an Officer will be able to receive information regarding an incident being reported by the Dispatcher or any other dispatching agency. In aspects of embodiments of the present invention, electronic components 102 and 104 may include electronic device(s) such as dash computers of law enforcement vehicles, mobile devices used by officers (e.g. tablets, phones etc.) that may be used to access main system component 106 of system 100. It should be noted that other electronic devices or components may be used and that the discussion of specific types of electronic devices herein is exemplary only and not limiting.

In another aspect of an embodiment of the present invention, system 100 may be located on one device such as electronic device 102 and/or 104. In which case, all operations described herein may be made possible on the same device.

Main system component 106 of system 100 may also include, in an aspect of an embodiment of the present invention, one or more processors 110 and memory 112. Main system component 106 may additionally include, according to aspects of embodiments of the present invention, incident response module 114A, supervisor resources module 114B, training module 114C and graphical user interface module 114D. It should be noted that additional modules may be included, and that illustration of operational modules 114A-D are exemplary only and not limiting.

In an aspect of an embodiment of the present invention, graphical user interface module 114D may include graphics interface generator 116 (which may include a graphics sub-processor for generating or displaying code embedded icons). In an aspect of an embodiment of the present invention, graphics interface generator 116 generates exemplary graphics interface 302, which, in an aspect of an embodiment of the present invention, may display code embedded icons 304A-304F, 306A-306R, 308A-308E, 310A-310E on display 300 upon different code executions by graphics interface generator 116.

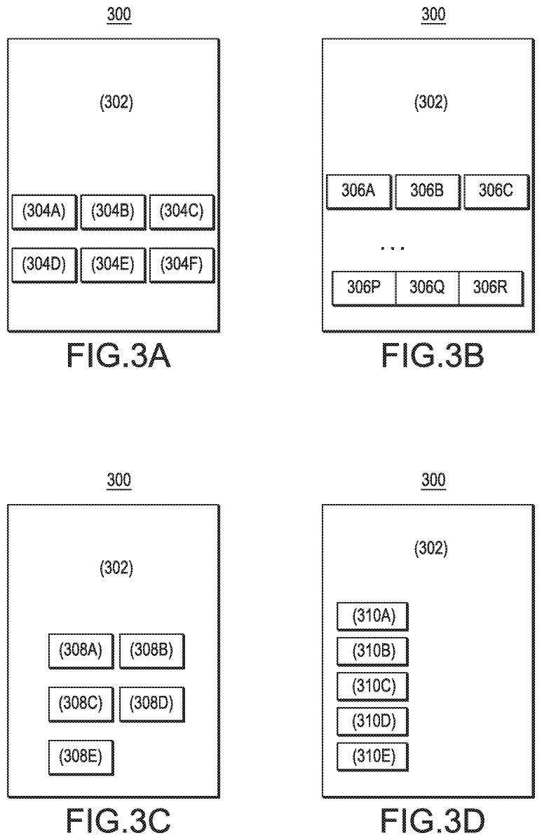

In an aspect of an embodiment of the present invention, the sub-processor of graphics interface generator 116 enables execution of code embedded within icons 304A-304F, 306A-306R, 308A-308E, and 310A-310E and other elements of graphics interface 302 to direct processor(s) 110 to particular pointers for the generation and population of graphics interface 302 with the corresponding data being pointed to. In another aspect of an embodiment of the present invention, graphical user interface module 114D may also direct processor(s) 110 to particular pointers using coded tabs in dropdown menus for each icons 304A-304F, 306A-306R, 308A-308E, and 310A-310E shown in FIGS. 3A-3D. In another aspect of an embodiment of the present invention, the operations of graphics interface generator 116 may be undertaken by processor(s) 110.

Each one of operational modules 114A-114D may be in communication with communication module 108, processor(s) 110 and memory 112, in which case, the operational modules may communicate directly and/or indirectly with electronic components or devices 102 and 104.

FIGS. 3A-3D illustrate exemplary operational screen displays 300 which may include graphics interface 302 which may include icons 304A-304F, 306A-306R, 308A-308E, and 310A-310E shown in FIGS. 3A-3D, operation of which, is further described in the description of process flow 200 below.

Process flow 200 for incident response module 114A may begin in step 202 with Officer notification of an incident by a Dispatcher or any other notifying entity. This may happen by way of the Dispatcher's communication with the Officer's electronic device 102. For the sake of simplicity, electronic device 102 would be used for the following description and is not meant to be limiting to electronic device 102 and the same operation may be possible for other electronic device(s), such as, for instance, electronic device 104.

Upon receipt of the notification, the Officer, in step 204, activates system 100 in step 204 and then incident response module 114A, in step 206, by selecting or tapping incident response icon 304A as displayed on display 300 of electronic device 102. In an aspect of an embodiment of the present invention, this activation may be made possible with the use of any or more or a combination of transducers, capacitive sensors, resistive sensors etc. which are represented by/displayed as icons on electronic device 102. In an aspect of an embodiment of the present invention the transducers could be, without limitation, physical, pressure or temperature transducers.

Following the Officer's selection of incident response module icon 304A, in step 206, icons 306A-306R, with each respectively representing incident response sub-modules 118A-118R, are displayed in step 208 by graphics interface generator 116. Sub-module icons 306A-306R are respectively representative of an assault sub-module (118A), a bomb threat sub-module (118B), a data entry sub-module (118C), a burglary sub-module (118D), a crash report sub-module (118E), a domestic violence sub-module (118F), a first aid sub-module (118G), a hazardous materials sub-module (118H), a juvenile complaint sub-module (118I), a mental health sub-module (118J), a missing persons sub-module (118K), a narcotics sub-module (118L), a sick call sub-module (118M), a suspicious persons sub-module (1180), a vandalism sub-module (118P), a weapons offenses sub-module (118Q), a weather event sub-module (118R). It should be noted that the list and specific identification of icons and/or sub-modules here are exemplary only and that additional or fewer icons and/or sub-modules are also contemplated according to aspects of embodiments of the present invention.

In an aspect of an embodiment of the present invention, graphics interface generator 116 enables this display by executing the embedded code in icon 304A once the icon is selected by the Officer. Next, in step 210 the Officer then selects the icon (one or more of 306A-306R) that matches the Incident type he/she is responding to.

In an aspect of an embodiment of the present invention, process 200 may, in step 212, query the Officer to either use the floor plans accessible on electronic device 102 and/or system 100 or input the address for the incident. In an aspect of an embodiment of the present invention, links to infrastructure databases may be provided to Officer's device 102 for the Officer to use. In another aspect of an embodiment of the present invention, process 200 just proceeds to step 220 in which different location types are displayed as icons and the Officer would then be able to select (step 222) the type and, subsequently (following further selection(s) by the Officer and having gone through additional menus) the display/download of the floor plans for the correct address in steps 216, 218.

In another aspect of an embodiment of the present invention, in lieu of a positive answer to query in step 212 (or in the absence of query step 212), process 200 enables officer input of the address in step 214. The entered address is then relayed to processor(s) 110, which then searches, obtains and relays the floor plans to electronic device 102 in step 216. In an aspect of an embodiment of the present invention, graphics interface generator 116 enables display of the floor plans on device 102.

Following display of the floor plans in either step 216, processor(s) 110, in step 218, then retrieves incident-specific information which could be any one or more of: at least one audio recording, at least one checklist, at least one response instruction, at least one display of an applicable law, a statute or a regulation, at least one audiovisual recording (located within memory structure(s) of each respective incident response sub-module 118A through 118R) onto Officer's electronic device 102.

In aspects of embodiments of the present invention, any one or more of the memory structure(s) contemplated herein may be part of or resident on memory 112. In another aspect of an embodiment of the present invention, any one or more of the memory structure(s) may be resident on different memory locations in addition to memory 112. In another aspect of an embodiment of the present invention, any one or more of the memory structure(s) may be resident on local memory (112), remote memory locations, databases and/or a combination of the foregoing. In a further aspect of an embodiment of the present invention any one or more of the memory structure(s) may be resident on the modules contemplated herein, local memory (112), remote memory locations, databases and/or a combination of the foregoing.

Following step 218, process 200, in step 226, plays corresponding audio or displays information from memory structure(s) of the sub-modules(s) 118A-118R on device 102. As an example, if the Officer selected incident response sub-module 118A i.e. Assault sub-module, then a checklist for questions to ask an assault victim or directions on how to approach an assault victim will be audially played for the Officer or visually displayed on his electronic device 102.

In another aspect of an embodiment, the floor plans may be remotely accessed from a remote server which would be linked to electronic device 102. In another aspect of an embodiment of the present invention, the floor plans may be accessible by way of activation/selection of floor plans icon 304B of display 300—activation of which, would lead to the display of the relevant floor plans or the provision of different options for the Officer with respect to the floor plans e.g. Officer address input etc.

In another aspect of an embodiment of the present invention, the information located within memory structure(s) of each respective incident response sub-module 118A through 118R may be displayed as a checklist on display 300 on the electronic device 102's display for the Officer to read which the Officer reviews before arriving at the scene, during which he/she exits vehicle and responds to the incident. Upon completion of the incident response, in an aspect of an embodiment of the present invention, process flow 200 may query, in step 228 whether the Officer needs to select an additional incident response sub-module. If the Officer's positively responds, then the process proceeds back to step 208. If the Officer replies negatively, the process then proceeds to step 230 in which the officer's negative response activates a reminder module whose icon may be displayed on display 300 by graphics interface generator 116. The Officer may then activate the reminder module by selecting the “Reminder” icon for the same previously selected incident type to ensure all tasks required to be completed with respect to the incident are/were completed prior to leaving the scene. A Reminder checklist is then displayed in step 232 for Officer review and checking, after which the Officer is queried as to whether he/she has completed review of the checklist in step 234. If the answer is in the affirmative, the process ends. If not, the process proceeds to step 228 of process flow 200. Implementation of this process may be made possible, in one aspect of an embodiment of the present invention, with the use of, inter alia, registers, pointers (for identification of the data bearing memory structure(s)).

In another aspect of an embodiment of the present invention, processor(s) 110, following the Officer's selection of one of incident sub-modules 118A-118R, link up electronic device 102 with the case law, statute, regulations for a download and/or display (in step 226) of the statutes/regulations relevant to the incident type. Alternatively, in an aspect of an embodiment of the present invention, these legal links or downloads may be displayed (after activation of icon 304C as displayed on display 300 in FIG. 3A) as icons 310A-310E, selection of which would activate graphic interface generator 116 to retrieve and display the relevant case law, statute, regulations for the Officer to review and apply to the incident he/she is responding to. In an aspect of an embodiment of the present invention, this process (i.e. the retrieval and display of the relevant case law, statute, regulations etc.) may take place before step 226 of process flow 200.

Operation of the Supervisor Resources Module

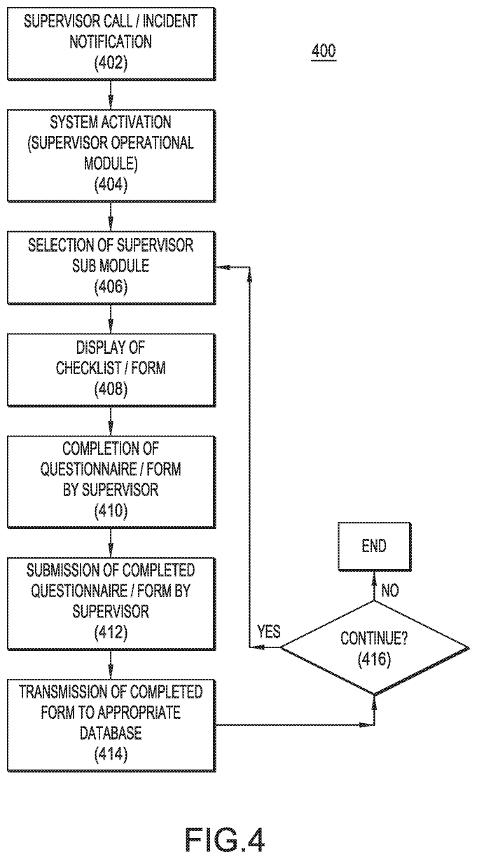

Referring now to FIGS. 1A, 1C, 3A, 4, 5A-5B an exemplary operational system 100, a Supervisor/Field Training Module or Resources Module 114B, an exemplary operational screen display 300, an exemplary supervisor resources module process flow 400, and an exemplary operational supervisor resources module screen display 500 as displayed on an exemplary electronic device are all shown according to aspects of embodiments of the present invention.

Supervisor resources module process flow 400 may begin with the Supervisor/Field Training Officer (FTO) monitoring a call from/notification by a Dispatcher or any other notifying entity in step 402. Once notified, the Supervisor then responds to the incident location as provided by the Dispatcher or notifying entity. The Supervisor/Field Training Module may then be activated in step 404 by the Supervisor selecting or tapping the “Supervisor Resource” icon 304D displayed on his electronic device 102. With activation of the icon 304D, graphics interface generator 116 then displays icons 502A-502E for sub-modules 120A through 120E on display 500 with each respectively representing Incident Command sub-module 120A, After-Action Review sub-module 120B, Daily Observation Review sub-module 120C, Performance Review sub-module 120D, and Body Worn Camera Review sub-module 120E. It should be noted that additional or fewer sub-modules are contemplated and the illustration of the aforementioned sub-modules is exemplary only and not limiting.

The Supervisor may then activate any one of a number of sub-modules 120A-120E depending on the action he/she wishes to pursue. Activation may be made possible by selection of icons representative of each sub-module (i.e. icons 502A-502E) in step 406. The process flow for each sub-module activation is presented below:

Incident Command

Activation of Incident Command sub-module 120A is done by Supervisor/FTO selection, in step 406, of the Incident Command icon 502A as it appears following selection of Supervisor Resources icon 304D. Following activation of incident command sub-module 120A, graphical interface generator or processor 116 then provides the Supervisor with access to, download of or display of the Incident Command checklist on device 102 in step 408 and the Supervisor/FTO may begin to complete tasks identified on checklist in step 410. In an aspect of an embodiment of the present invention, the checklist may be configured to receive input from the Supervisor to collect the Supervisor's checklist/questionnaire input.

Once all tasks are completed the Supervisor/FTO uploads this information by submitting same onto the incident command sub-module in step 412. The information, in step 414, is then transmitted and saved in a database for later access following the incident. The Supervisor is then queried in step 416 whether he/she wishes to complete another checklist/questionnaire for another sub-module. If the Supervisor's answer is in the affirmative, process flow 400 proceeds to step 406. If the Supervisor's answer is in the negative, then process flow 400 ends.

After Action Review

Activation of After-Action sub-module 120B is done by Supervisor/FTO selection, in step 406, of After-Action icon 502B as it appears following selection of the Supervisor Resources icon 304D. Following activation of After-Action sub-module 120B, graphical interface generator 116 then provides the Supervisor with access to, download of or display of the After-Action checklist on device 102 in step 408 and the Supervisor/FTO may begin to complete tasks identified on checklist in step 410. In an aspect of an embodiment of the present invention, the checklist may be configured to receive input from the Supervisor to collect the Supervisor's checklist/questionnaire input.

Once all tasks are completed the Supervisor/FTO uploads this information by submitting same onto After-Action sub-module 120B in step 412. The information, in step 414, is then transmitted and saved in a database for later access following the incident. The Supervisor is then queried in step 416 whether he/she wishes to complete another checklist/questionnaire for another sub-module. If the Supervisor's answer is in the affirmative, process flow 400 proceeds to step 406. If the Supervisor's answer is in the negative, then process flow 400 ends.

Daily Observation Report

Activation of Daily Observation Report sub-module 120C is done by Supervisor/FTO selection, in step 406, of Daily Observation Report icon 502C as it appears following selection of Supervisor Resources icon 304D. Following activation of Daily Observation Report sub-module 120C, graphical interface generator 116 then provides the Supervisor with access to, download of, or display of, the Daily Observation Report checklist on device 102 in step 408 and the Supervisor/FTO may begin to complete tasks identified on checklist in step 410. In an aspect of an embodiment of the present invention, the checklist may be configured to receive input from the Supervisor to collect the Supervisor's checklist/questionnaire input.

Once all tasks are completed the Supervisor/FTO uploads this information by submitting same onto Daily Observation Report sub-module 120C in step 412. The information, in step 414, is then transmitted and saved in a database for later access following the incident. The Supervisor is then queried in step 416 whether he/she wishes to complete another checklist/questionnaire for another sub-module. If the Supervisor's answer is in the affirmative, process flow 400 proceeds to step 406. If the Supervisor's answer is in the negative, then process flow 400 ends.

Performance Review

Activation of Performance Review sub-module 120D is done by Supervisor/FTO selection, in step 406, of Performance Review icon 502D as it appears following selection of Supervisor Resources icon 304D. Following activation of Performance Review sub-module 120D, graphical interface generator 116 then provides the Supervisor with access to, download of, or display of, the Performance Review checklist on device 102 in step 408 and the Supervisor/FTO may begin to complete tasks identified on checklist in step 410. In an aspect of an embodiment of the present invention, the checklist may be configured to receive input from the Supervisor to collect the Supervisor's checklist/questionnaire input.

Once all tasks are completed the Supervisor/FTO uploads this information by submitting same onto Performance Review sub-module 120D in step 412. The information, in step 414, is then transmitted and saved in a database for later access following the incident. The Supervisor is then queried in step 416 whether he/she wishes to complete another checklist/questionnaire for another sub-module. If the Supervisor's answer is in the affirmative, process flow 400 proceeds to step 406. If the Supervisor's answer is in the negative, then process flow 400 ends.

Body Worn Camera Review

This review occurs after the incident at the discretion of the Supervisor/FTO. Activation of the Body Worn Camera sub-module 120E is done by Supervisor/FTO selection, in step 406, of Body Worn Camera icon 502E as it appears following selection of Supervisor Resources icon 304D.

Access to, download of or display of the Body Worn Camera checklist on device 102 in step 410 is then made possible following activation of Body Worn Camera sub-module 120E and the Supervisor/FTO may begin to complete tasks or complete questions identified on the checklist based on Supervisor/FTO's observation of actions taken by officer on body worn camera.

Once all tasks are completed or once the questionnaire is completed, the Supervisor/FTO uploads this information in step 412 by submitting same onto the Body Worn Camera sub-module 120E. The information is then saved in a database in step 414 for later access following the incident and may be used as part of Training Needs Assessment, Risk Management, Early Warning System Resource Deployment planning.

Upon completion of any of the Supervisor resources sub-module, the Supervisor may return to the previous menu (displayed as 300 of FIG. 3A) by simply pressing a return to main menu button provided on each sub-module's display/screen.

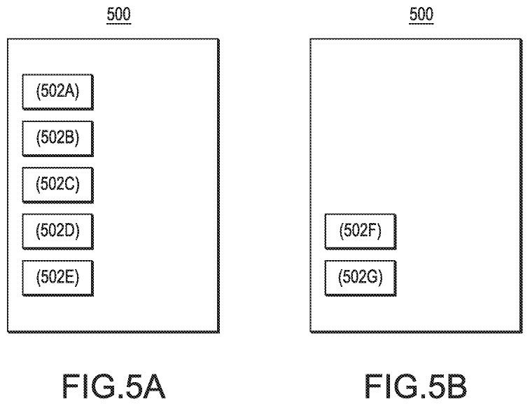

In an aspect of an embodiment of the present invention, Supervisor may be able to access Agency Contacts and a Chat facility by selecting icon 302F (representing Agency Contacts sub-module 120F) and icon 502G (representing and linking to Chat facility sub-module 120G) sub-module as displayed in FIG. 5B. Similar to the previous icons and sub-modules, Agency Contacts sub-module 120F is activated by the Supervisor's selection of the corresponding and linking icon 502F which prompts graphical interface generator 116 to display Agency Contacts sub-module icon 502F in FIG. 5B, which, with the Supervisor's further selection, displays contacts across the respective agency and/or a host of agencies. Selection of the Chat facility sub-module icon 502G activates Chat facility sub-module 120G (displayed as an icon 502G in FIG. 5B) which then enables the Supervisor to chat and exchange information with other individuals who have also been granted access to Chat facility sub-module 120G.

Operation of the Training Resources Module

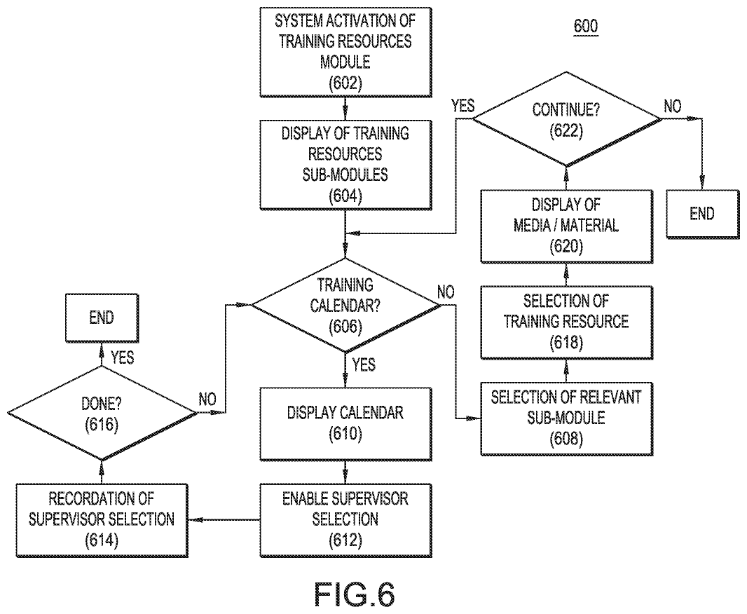

Referring now to FIGS. 1A, 1D, 6 and 7 an exemplary operational system 100, a Training Resources Module 114C, an exemplary Training Resources module process flow 600, and an exemplary operational Training Resources module screen display 700 as displayed on an exemplary electronic device are all shown according to aspects of embodiments of the present invention.

Operation of Training Resources module 114C may begin with the Officer's activation (in step 602) of Training Resources module 114C by selecting or tapping “Training Resource” icon 304F displayed on display 300 of electronic device 102. Following activation of the Training Resources module, additional sub-modules are then displayed and the process flow for each is described below:

Training Calendar

Operation and activation of the “Training Calendar” occurs after graphical interface generator 116 displays, in step 604, the Training Resources sub-module icons 702 through 712 on display 600 of electronic device 102 following activation of Training Resources module 114C in step 602. Process 600 in step 606 queries the Officer as to whether the Officer wishes to activate the Training Calendar sub-module 122A. If the Officer answers in the affirmative, then process 600 proceeds with the display of training calendar in step 610 on the electronic device's display 300 which enables the Officer's selection in step 612. Activation of Training Calendar sub-module 122A is made possible by the Officer's selection of Training Calendar icon 304F on display 300 of electronic device 102. Once selected/activated, Training Calendar sub-module 122A enables Officer to scroll through the calendar to view agency and individualized training events posted on the calendar. The Officer, in step 612, is also able to select specific date(s) or training event(s) after reviewing information related to the training event(s) (Topic, date, time, location, equipment needed, agency point of contact). Once the Officer has selected the desired training event, process 600 proceeds to step 614 when the Officer's selection is recorded and relayed to the proper information destination (e.g. agency scheduling department or event scheduling database). Operation of the Training Calendar sub-module 122A may then end with the Officer exiting the sub-module by clicking back (using, in one aspect, the back arrow of the display) to the main display of the electronic device. In another aspect of an embodiment of the present invention, the Officer may be queried in step 616 as to whether he/she wants to continue using the Training Resources sub-module 122A. If the Officer provides an affirmative answer, process 600 proceeds to step 608. If the Officer answers in the negative, process 600 ends and the Officer may either have the program ended or directed back to main menu 302 in FIG. 3A.

Incident Command

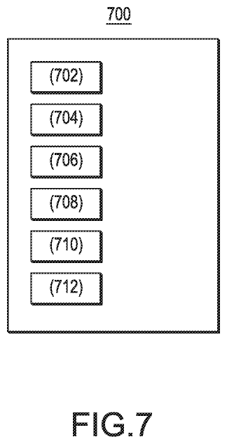

Operation and activation of the “Incident Command” occurs after graphical interface generator 116 displays, in step 604, the Training Resources sub-module icons 702 through 712 on display 700 of electronic device 102 following activation of Training Resources module 114C in step 602. Activation of sub-module icon 704 takes process 600 (after the Officer opts not to proceed with the Training Calendar sub-module 122A in step 606) to step 608 with the Officer's selection of Incident Command sub-module 122B in step 608 by selecting Incident Command sub-module icon 704. Process 600 then proceeds to step 618 where the Officer Office determines which training resource he/she wishes to view. Once activated, the Incident Command sub-module retrieves information on training videos/material from memory and displays same in step 620 on electronic device 102's display 700 from which the Officer may then select for viewing. Operation of Incident Command sub-module 122B may then end with the Officer finishing the video or exiting the sub-module by clicking back (using, in one aspect, the back arrow of the display) to the main display of the electronic device. In another aspect of an embodiment of the present invention, process 600 may query the Officer if he/she wishes to continue use of the Incident Command sub-module 122B in step 622. If the Officer answers in the affirmative, process 600 proceeds to step 604. If not, the process ends or, in another aspect of an embodiment of the present invention, the Officer may be directed back to the main menu displayed on display 700 in FIG. 7 or the main display 300 in FIG. 3A.

Mass Casualty

Operation and activation of the “Mass Casualty” sub-module 122C occurs after graphical interface generator 116 displays, in step 604, the Training Resources sub-module icons 702 through 712 on display 700 of electronic device 102 following activation of Training Resources module 114C in step 602. Activation of sub-module icon 706 takes process 600 (after the Officer opts not to proceed with the Training Calendar sub-module 122A in step 606) to step 608 with the Officer's selection of Mass Casualty sub-module 122C by selecting Mass Casualty sub-module icon 706. Process 600 then proceeds to step 618 where the Officer Office determines which training resource he/she wishes to view. Once activated, the Mass Casualty sub-module retrieves information on training videos/material from memory and displays same in step 620 on electronic device 102's display 700 from which the Officer may then select for viewing. Operation of Mass Casualty sub-module 122C may then end with the Officer finishing the video or exiting the sub-module by clicking back (using, in one aspect, the back arrow of the display) to the main display of the electronic device. In another aspect of an embodiment of the present invention, process 600 may query the Officer if he/she wishes to continue use of the Mass Casualty sub-module 122C in step 622. If the Officer answers in the affirmative, process 600 proceeds to step 604. If not, the process ends or, in another aspect of an embodiment of the present invention, the Officer may be directed back to the main menu displayed on display 700 in FIG. 7 or the main display 300 in FIG. 3A.

Crime Scene

Operation and activation of the “Crime Scene” sub-module 122D occurs after graphical interface generator 116 displays, in step 604, the Training Resources sub-module icons 702 through 712 on display 700 of electronic device 102 following activation of Training Resources module 114C in step 602. Activation of sub-module icon 708 takes process 600 (after the Officer opts not to proceed with the Training Calendar sub-module 122A in step 606) to step 608 with the Officer's selection of Crime Scene sub-module 122D in step 608 by selecting Crime Scene sub-module icon 708. Process 600 then proceeds to step 618 where the Officer Office determines which training resource he/she wishes to view. Once activated, the Crime Scene sub-module retrieves information on training videos/material from memory and displays same in step 620 on electronic device 102's display 700 from which the Officer may then select for viewing. Operation of Crime Scene sub-module 122D may then end with the Officer finishing the video or exiting the sub-module by clicking back (using, in one aspect, the back arrow of the display) to the main display of the electronic device. In another aspect of an embodiment of the present invention, process 600 may query the Officer if he/she wishes to continue use of the Crime Scene sub-module 122D in step 622. If the Officer answers in the affirmative, process 600 proceeds to step 604. If not, the process ends or, in another aspect of an embodiment of the present invention, the Officer may be directed back to the main menu displayed on display 700 in FIG. 7 or the main display 300 in FIG. 3A.

Medical

Operation and activation of the “Medical” sub-module 122E occurs after graphical interface generator 116 displays, in step 604, the Training Resources sub-module icons 702 through 712 on display 700 of electronic device 102 following activation of Training Resources module 114C in step 602. Activation of sub-module icon 710 takes process 600 (after the Officer opts not to proceed with the Training Calendar sub-module 122A in step 606) to step 608 with the Officer's selection of Medical sub-module 122E in step 608 by selecting Medical sub-module icon 710. Process 600 then proceeds to step 618 where the Officer Office determines which training resource he/she wishes to view. Once activated, the Medical sub-module retrieves information on training videos/material from memory and displays same in step 620 on electronic device 102's display 700 from which the Officer may then select for viewing. Operation of Medical sub-module 122E may then end with the Officer finishing the video or exiting the sub-module by clicking back (using, in one aspect, the back arrow of the display) to the main display of the electronic device. In another aspect of an embodiment of the present invention, process 600 may query the Officer if he/she wishes to continue use of the Medical sub-module 122E in step 622. If the Officer answers in the affirmative, process 600 proceeds to step 604. If not, the process ends or, in another aspect of an embodiment of the present invention, the Officer may be directed back to the main menu displayed on display 700 in FIG. 7 or the main display 300 in FIG. 3A.

Patrol Tactics

Operation and activation of the “Patrol Tactics” sub-module 122F occurs after graphical interface generator 116 displays, in step 604, the Training Resources sub-module icons 702 through 712 on display 700 of electronic device 102 following activation of Training Resources module 114C in step 602. Activation of sub-module icon 712 takes process 600 (after the Officer opts not to proceed with the Training Calendar sub-module 122A in step 606) to step 608 with the Officer's selection of Patrol Tactics sub-module 122F in step 608 by selecting Patrol Tactics sub-module icon 712. Process 600 then proceeds to step 618 where the Officer Office determines which training resource he/she wishes to view. Once activated, the Patrol Tactics sub-module retrieves information on training videos/material from memory and displays same in step 620 on electronic device 102's display 700 from which the Officer may then select for viewing. Operation of Patrol Tactics sub-module 122F may then end with the Officer finishing the video or exiting the sub-module by clicking back (using, in one aspect, the back arrow of the display) to the main display of the electronic device. In another aspect of an embodiment of the present invention, process 600 may query the Officer if he/she wishes to continue use of the Patrol Tactics sub-module 122F in step 622. If the Officer answers in the affirmative, process 600 proceeds to step 604. If not, the process ends or, in another aspect of an embodiment of the present invention, the Officer may be directed back to the main menu displayed on display 700 in FIG. 7 or the main display 300 in FIG. 3A.

In an aspect of an embodiment of the present invention, graphical interface generator/processor 116 may be responsible for all displays of aforementioned icons, displays (also known as screens), information as displayed on any one or more of screens or displays 300, 500, 700. Graphical interface generator/processor 116 may also be responsible with the switching of from one display to another on each screen following execution of the code embedded icons on each screen. In another aspect of an embodiment of the present invention, operations of graphical interface processor 116 as outlined above may be undertaken by processor(s) 110.

Although this present invention has been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features—all without departing from the present invention as outlined above, in the appended drawings and the claims presented below.

What is claimed is:

1. A system for performance management, comprising:
at least one processor, wherein the at least one processor performs a predefined set of basic operations in response to receiving a corresponding basic instruction selected from a predefined native instruction set of codes;
memory in communication with said at least one processor;
at least one operational module, wherein said at least one operational module comprises of any one or more of: an incident response module, a supervisor resources module, a training resources module, a floor plan module, a chat module, a laws, statutes and regulations module, a reminder module, wherein said at least one operational module is in communication with the at least one processor, wherein said at least one operational module comprises of at least one sub-module;
a display module in communication with the at least one processor; and
a transceiver module for receipt and transmission of data to and from at least one electronic device in communication with said system, wherein said at least one operational module is represented as an icon on a display, wherein each icon comprises of embedded code execution of which activates operation of said at least one operational module, leading to display of at least one sub-module icons representing said at least one sub-module, wherein said at least one sub-module icon comprises of embedded code, execution of which activates said at least one sub-module.

2. The system of claim 1, wherein said at least one sub-module comprises of any of: at least one memory structure, a pointer to at least one memory structure, wherein activation of said at least one sub-module, by selection of said representative icons of said at least one sub-module, produces agency approved information for a specific said at least one operational module, wherein said agency approved information is any one or more of: at least one audio recording, at least one checklist, at least one response instruction, at least one display of an applicable law, a statute or a regulation, at least one fillable form, at least one floor plan, at least one audiovisual recording.

3. The system of claim 2, wherein agency approved information is resident on said at least one memory structure.

4. The system of claim 1, wherein execution of the embedded code is done by any one or more of: physical contact, pressure, temperature contact of said at least one icon on the display.

5. A computer implemented method of performance management, comprising, executing on at least one processor, which performs a predefined set of basic operations in response to receiving a corresponding basic instruction selected from a predefined native instruction set of codes, execution of which enable operational steps of any one or more of:
an incident response module;
a supervisor resources module; and
a training resources module.

6. The computer-implemented method of claim 5, wherein operational steps of the incident response module comprises:
activating said incident response module by selecting an incident response module icon representative of said incident response module on an electronic device wherein selection of said incident response module icon executes code embedded within said incident response module icon;
display of at least one incident response sub-module icon;
selection of said at least one incident response sub-module icon, wherein said selection executes code embedded within said at least one incident response sub-module icon thereby activating at least one incident response sub-module;
production of agency approved information for said at least one operational module, wherein said agency approved information is any one or more of: at least one audio recording, at least one checklist, at least one response instruction, at least one display of an applicable law, a statute or a regulation, at least one fillable form, at least one floor plan, at least one audiovisual recording; and
operation of a reminder module, wherein said reminder module is activated by any of: user activation of a reminder icon on said electronic device wherein selection of the icon executes code embedded within the icon, automatic activation following production of agency approved information, wherein activation of said reminder module comprises of provision of any one or more of: at least one reminder checklist, audio play of at least one reminder.

7. The computer-implemented method of claim 5, wherein operational steps of the supervisor resources module comprises:
activating said supervisor resources module by selecting a supervisor resources module icon representative of said supervisor resources module on an electronic device wherein selection of said supervisor resources module icon executes code embedded within said supervisor resources module icon;
display of at least one supervisor resources sub-module icon;
selection of said at least one supervisor resources sub-module icon, wherein said selection executes code embedded within said at least one supervisor resources sub-module icon thereby activating at least one supervisor resources sub-module;
display of any one or more of: at least one checklist, at least one questionnaire, at least one form on said electronic device;
collection of input by a user in response to said any one or more of: at least one checklist, at least one questionnaire, at least one form on said electronic device;
submission of said collected input to at least one database; and
recordation of said collected input on said at least one database.

8. The computer-implemented method of claim 5, wherein operational steps of the training resources module comprises:
activating said training resources module by selecting a training resources module icon representative of said training resources module on an electronic device wherein selection of said training resources module icon executes code embedded within said training resources module icon;
display of at least one training resources sub-module icon; and
selection of said at least one training resources sub-module icon, wherein said selection executes code embedded within said at least one training resources sub-module icon thereby activating at least one training resources sub-module.

9. The computer-implemented method of claim 8, wherein activation of said at least one training resources sub-module comprises:
display of at least one training calendar, wherein said at least one training calendar comprises of at least one agency and individualized training events posted on said at least one training calendar;
enabling selection of said at least one agency and individualized training event posted on said at least one training calendar, wherein said selection is by any one of: date selection, event selection; and
recordation of said selection.

10. The computer-implemented method of claim 8, wherein activation of said at least one training resources sub-module comprises:
display of at least one training resource on said electronic device;
enabling selection of said at least one training resource as displayed on said electronic device; and
enabling operation on said selected at least one training resource, wherein said operation is any one or more of: download of said at least one training resource onto said electronic device, play of said at least one training resource on said electronic device.

11. A computer program product comprising a non-transitory computer-readable storage medium having computer-readable code embodied in the medium which, when executed on at least one processor activate/initiate operation of any one or more of:
an incident response module;
a supervisor resources module; and
a training resources module.

12. The computer program product of claim 11, wherein the computer-readable code for the operation of the incident response module comprises computer-readable code for:
activating said incident response module by selecting an incident response module icon representative of said incident response module on an electronic device wherein selection of said incident response module icon executes code embedded within said incident response module icon;
display of at least one incident response sub-module icon;
selection of said at least one incident response sub-module icon, wherein said selection executes code embedded within said at least one incident response sub-module icon thereby activating at least one incident response sub-module;
production of agency approved information for said at least one operational module, wherein said agency approved information is any one or more of: at least one audio recording, at least one checklist, at least one response instruction, at least one display of an applicable law, a statute or a regulation, at least one fillable form, at least one floor plan, at least one audiovisual recording; and
operation of a reminder module, wherein said reminder module is activated by any of: user activation of a reminder icon on said electronic device wherein selection of the icon executes code embedded within the icon, automatic activation following production of agency approved information, wherein activation of said reminder module comprises of provision of any one or more of: at least one reminder checklist, audio play of at least one reminder.

13. The computer program product of claim 11, wherein the computer-readable code for the operation of the supervisor resources module comprises computer-readable code for:
activating said supervisor resources module by selecting a supervisor resources module icon representative of said supervisor resources module on an electronic device wherein selection of said supervisor resources module icon executes code embedded within said supervisor resources module icon;
display of at least one supervisor resources sub-module icon;
selection of said at least one supervisor resources sub-module icon, wherein said selection executes code embedded within said at least one supervisor resources sub-module icon thereby activating at least one supervisor resources sub-module;
display of any one or more of: at least one checklist, at least one questionnaire, at least one form on said electronic device;
collection of input by a user in response to said any one or more of: at least one checklist, at least one questionnaire, at least one form on said electronic device;
submission of said collected input to at least one database; and
recordation of said collected input on said at least one database.

14. The computer program product of claim 11, wherein the computer-readable code for the operation of the training resources module comprises computer-readable code for:
activating said training resources module by selecting a training resources module icon representative of said training resources module on an electronic device wherein selection of said training resources module icon executes code embedded within said training resources module icon;
display of at least one training resources sub-module icon; and
selection of said at least one training resources sub-module icon, wherein said selection executes code embedded within said at least one training resources sub-module icon thereby activating at least one training resources sub-module.

15. The computer program product of claim 14, wherein the computer-readable code for the operation of said training resources sub-module comprises computer-readable code for:
display of at least one training calendar, wherein said at least one training calendar comprises of at least one agency and individualized training events posted on said at least one training calendar;
enabling selection of said at least one agency and individualized training event posted on said at least one training calendar, wherein said selection is by any one of: date selection, event selection; and
recordation of said selection.

16. The computer program product of claim 15, wherein the computer-readable code for the operation of said training resources sub-module comprises computer-readable code for:
display of at least one training resource on said electronic device;
enabling selection of said at least one training resource as displayed on said electronic device; and
enabling operation on said selected at least one training resource, wherein said operation is any one or more of: download of said at least one training resource onto said electronic device, play of said at least one training resource on said electronic device.

17. A method for displaying a performance management screen, comprising, executing on at least one graphical interface processor, which performs a predefined set of basic operations in response to receiving a corresponding basic instruction selected from a predefined native instruction set of codes, execution of which enable any one or more of:
dynamically displaying an icon representative of an incident response module;
dynamically displaying an icon representative of a supervisor resources module; and
dynamically displaying an icon representative of a training resources module, wherein each icon comprises of embedded code, execution of which activates a module of which said icon is respectively representative of.

18. The method of claim 17, further comprising:
dynamically displaying at least one incident response sub-module icon by selecting said incident response module icon representative of said incident response module on said screen wherein selection of said incident response module icon executes code embedded within said incident response module icon;
activating at least one incident response sub-module, wherein activation is effected by selection of said at least one incident response sub-module icon, wherein said selection executes code embedded within said at least one incident response sub-module icon;
displaying agency approved information for said at least one incident response sub-module, wherein said agency approved information is any one or more of: at least one audio recording, at least one checklist, at least one response instruction, at least one display of an applicable law, a statute or a regulation, at least one fillable form, at least one floor plan, at least one audiovisual recording; and
display of a reminder module, wherein said reminder module is activated by any of: user activation of a reminder icon on said screen wherein selection of the icon executes code embedded within the icon, automatic activation following production of agency approved information, wherein activation of said reminder module comprises of display of any one or more of: at least one reminder checklist, audio play of at least one reminder.

19. The method of claim 17, further comprising:
dynamically displaying at least one supervisor resources sub-module icon by selecting said supervisor resources module icon representative of said supervisor resources module on said screen wherein selection of said supervisor resources module icon executes code embedded within said supervisor resources module icon;
selection of said at least one supervisor resources sub-module icon, wherein said selection executes code embedded within said at least one supervisor resources sub-module icon thereby activating at least one supervisor resources sub-module;
display of any one or more of: at least one checklist, at least one questionnaire, at least one form on said screen;
display of user input on said screen in response to said any one or more of: at least one checklist, at least one questionnaire, at least one form on said electronic device;
submission of said user input to at least one database; and
recordation of said user input on said at least one database.

20. The method of claim 17, further comprising:
dynamically displaying at least one training resources sub-module icon by selecting said training resources module icon representative of said training resources module on said screen, wherein selection of said training resources module icon executes code embedded within said training resources module icon; and
activating said at least one training resources sub-module by selection of said at least one training resources sub-module icon, wherein said selection executes code embedded within said at least one training resources sub-module icon.

21. The method of claim 17, further comprising:
dynamically displaying at least one training resources sub-module icon by selecting said training resources module icon representative of said training resources module on said screen, wherein selection of said training resources module icon executes code embedded within said training resources module icon;
display of at least one training calendar, wherein said at least one training calendar comprises of at least one agency and individualized training event posted on said at least one training calendar;
enabling selection of said at least one agency and individualized training event posted on said at least one training calendar, wherein said selection is by any one of: date selection, event selection; and
recordation of said selection.

22. The method of claim 17, further comprising:
dynamically displaying at least one training resource on said screen by selecting said training resources module icon representative of said training resources module on said screen, wherein selection of said training resources module icon executes code embedded within said training resources module icon; and
enabling operation on said selected at least one training resource, wherein said operation is any one or more of: download of said at least one training resource, play of said at least one training resource on said screen.
